(19) United States
(12) Patent Application Publication
(10) Pub. No.: US 2010/0037787 A1
(43) Pub. Date: Feb. 18, 2010

(54) ROTARY FOOD CUTTER WITH REMOVABLE BLADE ASSEMBLY

(76) Inventors: Annbjorg Eide, Elmira, NY (US); Deborah A. Green-Cotton, Chicago, IL (US); Paul Hatch, Chicago, IL (US); Howard Cheng, Chicago, IL (US); Julia Barrett Burke, Chicago, IL (US); Siarhei Murauyou, Chicago, IL (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/191,082

(22) Filed: Aug. 13, 2008

(51) Int. Cl. A47J 43/04; B26B 3/00; B26B 1/00; B26D 1/00

(52) U.S. Cl. 99/538; 30/319; 30/329; 83/13

(57) ABSTRACT

A rotary food cutting device is provided. The rotary food cutting device comprises a handle assembly and a removable blade assembly. The removable blade assembly has a blade, a first blade mounting member, and a second blade mounting member. The blade is positioned between the first blade mounting member and the second blade mounting member. The first blade mounting member and the second blade mounting member interact with the handle assembly to removably secure the blade.

### TECHNICAL FIELD

The present invention relates to a rotary food cutter, and more particularly, to a rotary food cutter with a removable blade assembly.

### BACKGROUND OF THE INVENTION

When preparing and serving foods, it is common to utilize a rotary food cutter to cut the subject food item. For instance, when preparing a pie, a rotary cutter may be used to cut excess dough from a crust. An even more well-known example used when serving food is a rotary style pizza cutter used to slice pizza after it is baked. Rotary cutters are popular because of their ease of use and versatility. However, past rotary cutters have also had inherent shortcomings. For example, past rotary cutters have been difficult to clean after use. This is typically due to the fact that many rotary cutters have blades that are fixedly attached to the body of the rotary cutter by secured fasteners, such as, for example, a rivet or other such fastener. As a result, food particles often become lodged on or proximate portions of the blade that are not easily accessible while the blade is attached to the rotary cutter.

Thus, it would be useful to provide a rotary cutter that allows access to typically difficult to clean areas of the rotary cutter. Further, it would be useful to provide a rotary cutter configured to allow blade replacement; particularly in instances in which the blade becomes dull, or in which a different type of blade may be useful for different culinary uses. Therefore, a need exists for a rotary food cutter with an easily removable blade and associate blade assembly.

The present invention is provided to solve the problems discussed above and other problems, and to provide advantages and aspects not previously provided. A full discussion of the features and advantages of the present invention is deferred to the following detailed description, which proceeds with reference to the accompanying drawings.

### SUMMARY OF THE INVENTION

According to one embodiment, a rotary food cutting device is comprised of a handle assembly and a removable blade assembly. The removable blade assembly has a first blade mounting member, and a second blade mounting member which together define a blade locking mechanism. A blade is positioned between the first blade mounting member and the second blade mounting member. The first blade mounting member and the second blade mounting member interact with a portion of the handle assembly to removably secure the blade.

According to another embodiment, a removable blade assembly for a rotary food cutter is comprised of a first blade mounting member and a second blade mounting member which together define a blade locking mechanism. The blade assembly also includes a rotary food cutting blade. The first blade mounting member has a displaceable arm, a rotary cutting blade bearing surface, and a male interlocking member. The displaceable arm has a ledge at a distal end of the arm. The male interlocking member is concentric to the rotary cutting blade bearing surface. The male interlocking member extends in an axial direction beyond the rotary cutting blade bearing surface towards a center of the removable blade assembly. The second blade mounting member has a displaceable arm and a female interlocking member. The displaceable arm has a ledge at a distal end of the arm. The female interlocking member forms a recess in an axial direction. The male interlocking member of the first blade mounting member projects into the female interlocking member of the second blade mounting member to fix the position of the first blade mounting member relative to the second blade mounting member. The rotary food cutting blade has a generally circular opening formed near the center of the food cutting blade. The rotary food cutting blade is supported by the rotary cutting blade bearing surface of the first blade mounting member. The blade bearing surface projects through the generally circular opening of the rotary cutting blade.

According to one process of the present invention, a method of operating a rotary food cutter is disclosed. The method provides a handle assembly and a removable blade assembly. The removable blade assembly has a blade, and a blade locking mechanism defined by a first blade mounting member and a second blade mounting member. The first blade mounting member has a first displaceable arm with a generally laterally protruding ledge at a distal end of the arm. The first blade mounting member also has a blade bearing surface that supports the blade during use of the rotary cutter. The second blade mounting member has a second displaceable arm with a generally laterally protruding ledge at a distal end of the arm. The blade is removably secured between the first blade mounting member and the second blade mounting member. A force is applied to the displaceable arms to bend the displaceable arms that move the laterally protruding ledges of the blade mounting members to a disengaged position. The removable blade assembly is removed from the handle assembly. The removable blade assembly is separated by pulling the first blade mounting member away from the second blade mounting member.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1a is a left perspective view of a rotary cutter according to one embodiment of the present invention;

FIG. 1b is a right perspective view of a rotary cutter according to one embodiment of the present invention;

FIG. 2 is perspective view of the rotary cutter shown in FIG. 1a showing the removable blade assembly removed;

FIG. 3 is an exploded view of the rotary cutter shown in FIG. 1;

FIG. 4 is an exploded view of a removable blade assembly of the rotary cutter shown in FIG. 1;

FIG. 5a is a left perspective view of a portion of a handle assembly and a first blade mounting member of the rotary food cutter shown in FIG. 1a;

FIG. 5b is a right perspective view of a portion of a handle assembly and a second blade mounting member of the rotary food cutter shown in FIG. 1b;

FIG. 6 is a perspective view of a portion of the handle assembly of the rotary cutter shown in FIG. 1a.

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

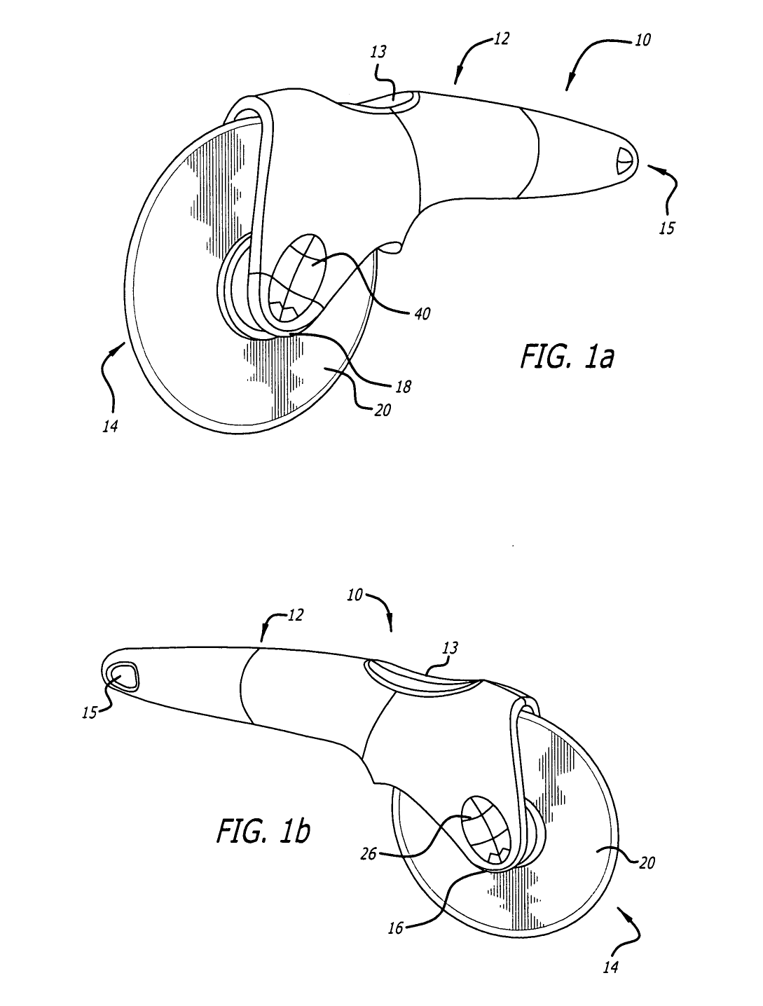

According to one embodiment of the present invention as shown in FIGS. 1-3, a rotary cutter 10 is provided. As will be discussed below, according to one aspect of the invention, the rotary cutter 10 comprises a handle assembly 12 and a removable blade assembly 14. The handle assembly 12 comprises a first body member 12a and a second body member 12b. The first body member 12a and the second body member 12b join together along a longitudinal axis to form the handle assembly 12. It is contemplated that the first body member 12a may be connected to the second body member 12b in a variety if manners, such as, a friction fit, an adhesive bond, mechanical fasteners, or other known fastening manners. As shown in FIGS. 1-3, the handle assembly additionally forms a thumb grip 13 located about a top surface of the handle assembly 12 when the rotary food cutter 10 is in use. The thumb grip 13 forms a generally convex depression in the handle assembly 12 to allow a user to better guide the rotary cutter 10 while in use. It is also contemplated, according to alternative embodiments, that the thumb grip 13 may include a slip resistant material, such as rubber or other such material. It is also contemplated that the thumb grip may have a different shape. In addition to the thumb grip 13, it is contemplated that the handle assembly 12 may also have a through hole 15 formed therein. The through hole 15 allows the rotary cutter 10 to hang on a hook or other instrument when being stored. Alternatively, the through hole 15 may receive a hook or be fitted with a magnet to allow the cutter 10 to be hung from a surface.

The first body member 12a further has a first lateral slot or aperture 17 adapted to interact with the removable blade assembly 14, while the second body member 12b has a second lateral slot or aperture 19 (FIG. 6) adapted to interact with the removable blade assembly 14. The first and second lateral slots 17, 19 allow the removable blade assembly 14 to be removeably mounted to the handle assembly 12.

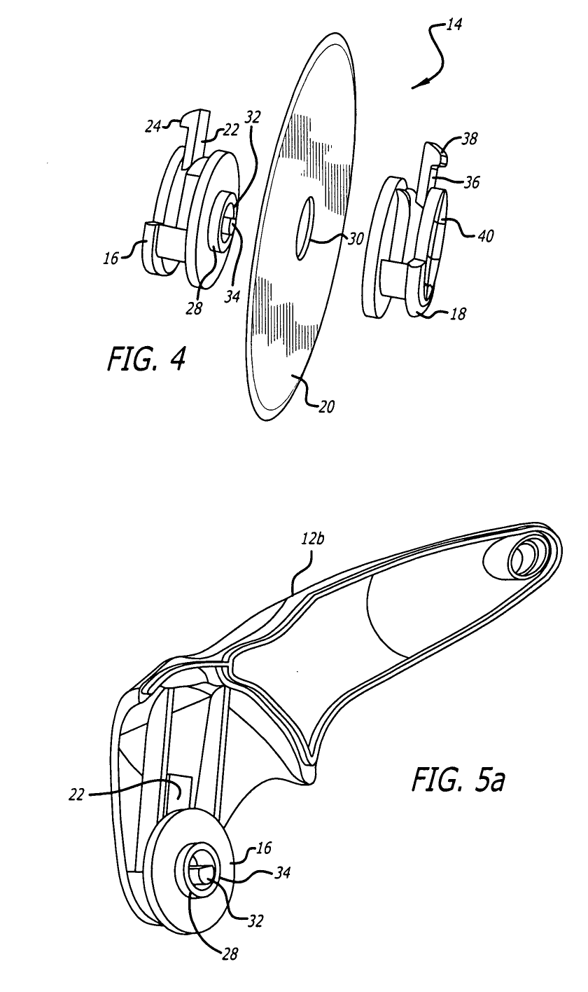

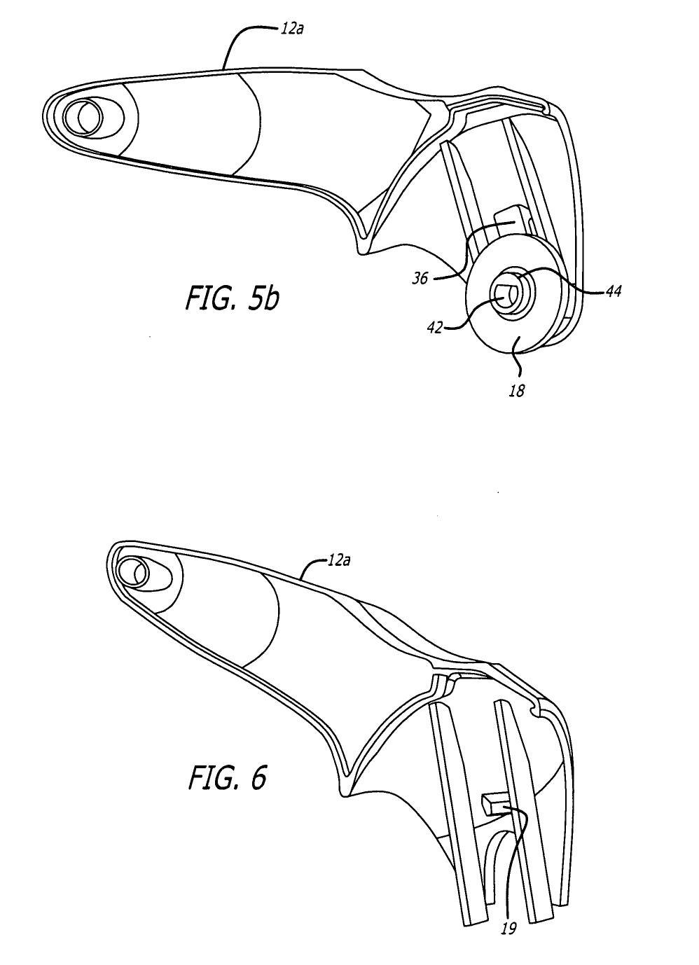

As shown in FIG. 4, the removable blade assembly 14 comprises a first blade mounting member 16, a second blade mounting member 18, and a blade 20. The first and second blade mounting members 16, 18 cooperatively define a blade locking mechanism. The blade locking mechanism provides for removable coupling engagement of the removable blade assembly 14 and the handle assembly 12. The blade 20 is coupled to the blade locking mechanism and is positioned between the first blade mounting member 16 and the second blade mounting member 18.

As shown in FIG. 4, the first blade mounting member 16 has a displaceable arm 22 with a generally laterally protruding ledge 24 at a distal end of the displaceable arm 22. The generally laterally protruding ledge 24 is adapted to be positioned within the first lateral slot 17 when the removable blade assembly 14 is mounted to the handle assembly 12. The displaceable arm 22 connects to a first release surface 26. The first release surface 26 has a generally concave shape, such as to be ergonomically shaped to match a finger. In use, a user may press against the first release surface 26, causing a portion of the first blade mounting member 16 near the first release surface 26 to deflect towards a center of the rotary food cutter 10. Deflecting the first mounting member 16 causes the displaceable arm 22 to also deflect towards the center of the rotary food cutter 10, thus resulting in the laterally protruding ledge 24 exiting the first lateral slot 17 of the handle assembly 12.

In addition to the displaceable arm 22, the first blade mounting member 16 further has a blade bearing surface 28. The blade bearing surface 28 is adapted to support the blade 20 when the blade 20 is mounted between the first blade mounting member 16 and the second blade mounting member 18. The blade 20 forms a through hole 30 generally at a center portion of the blade 20. The first blade mounting member 16 additionally has a male interlocking member 32. According to one preferred embodiment, the male interlocking member 32 is concentric to the blade bearing surface 28 and extends axially beyond the blade bearing surface 28 towards the center of the rotary food cutter 10. The male interlocking member 32 further has an alignment feature 34. The alignment feature 34 assists in aligning the first blade mounting member 16 with the second blade mounting member 18. As shown in FIG. 4, the alignment feature 34 is a generally flat surface. It is contemplated, however, that the alignment feature may take other forms, such as splines, recesses, or other geometry or features that would limit the ability of the first blade mounting member 16 to be positioned relative to the second blade mounting member 18 while in use.

The second blade mounting member 18 has a displaceable arm 36 with a generally laterally protruding ledge 38 at a distal end of the displaceable arm 36. The generally protruding ledge 38 is adapted to be positioned within the second lateral slot 19 when the removable mounting assembly 14 is mounted to the handle assembly 12. The displaceable arm 36 connects to a second release surface 40. According to one preferred embodiment, the second release surface 40 has a generally concave shape, such as to be ergonomically shaped to match a finger. In use, a user may press against the second release surface 40, causing a portion of the second blade mounting member 18 near the second release surface 40 to deflect towards a center of the rotary food cutter 10. Deflecting the second blade mounting member 18 causes the displaceable arm 36 to also deflect towards the center of the rotary food cutter 10, thus resulting in the laterally protruding ledge 38 exiting the second lateral slot 19 of the handle assembly 12.

In addition to the displaceable arm 36, the second blade mounting member 18 further has a female interlocking member 42. The female interlocking member 42 extends axially towards the center of the rotary food cutter 10. The female interlocking member 42 further has an alignment feature 44. The alignment feature 44 assists in aligning the second blade mounting member 18 with the first blade mounting member 16. As shown in FIG. 6, the alignment feature 44 is a generally flat surface of the female interlocking member 42.

In use, the male interlocking member 32 of the first blade mounting member 16 is received by the female interlocking member 42 of the second blade mounting member 18. The male interlocking member 32 projects into the female interlocking member 42. The alignment feature 34 of the male interlocking member 32 interacts with the alignment feature 44 of the female interlocking member 42 to rotationally fix the first blade mounting member 16 relative to the second blade mounting member 18.

In operation, a compressive force directed towards the center of the rotary food cutter 10 is applied to the first release surface 26 of the first blade mounting member 16 to remove the removable blade assembly 14 from the handle assembly 12. The compressive force causes an area of the first blade mounting member 16 near the first release surface 26 to deflect towards the center of the rotary food cutter 10. The inward deflection results in the displaceable arm 22 of the first blade mounting member 16 moving towards the center of the rotary food cutter 10, disengaging the protruding ledge 24 of the displaceable arm 22 from the first lateral slot 17 of the handle assembly 12.

At about the same time that the compressive force is applied to the first blade mounting member 16, a similar but complimentary compressive force directed towards the center of the rotary food cutter 10 is applied to the second release surface 40 of the second blade mounting member 18. The compressive force causes an area of the second blade mounting member 18 near the second release surface 40 to deflect towards the center of the rotary food cutter 10. The inward deflection results in the displaceable arm 36 of the second blade mounting member 18 moving towards the center of the rotary food cutter 10, disengaging the protruding ledge 38 of the displaceable arm 36 from the second lateral slot 19 of the handle assembly 12.

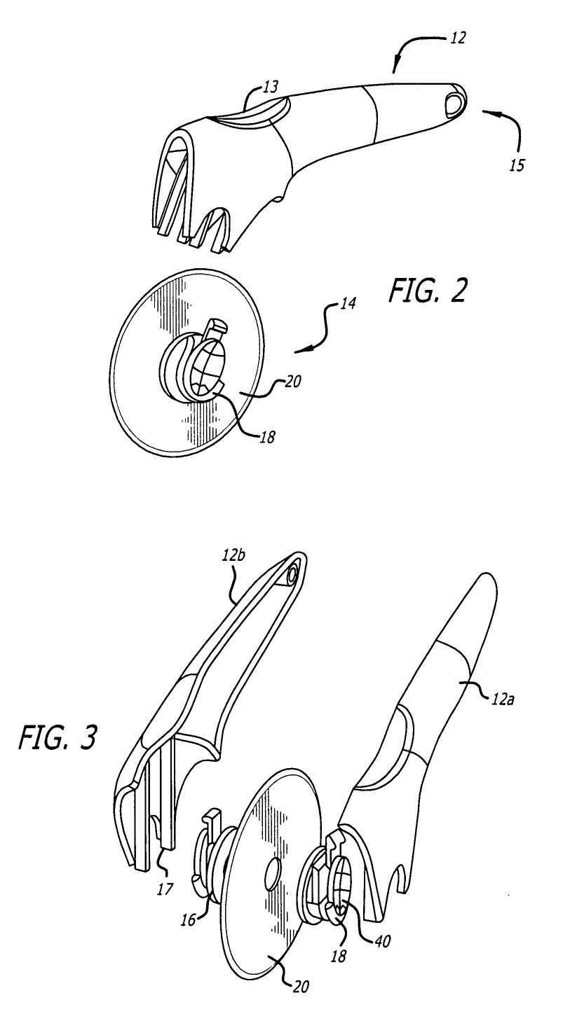

While the compressive forces described above are being applied to the first release surface 26 and the second release surface 40 of the respective first and second blade mounting members 16, 18, a removal force is applied in the direction of arrow A shown in FIG. 1a. As the compressive forces have disengaged the protruding ledges 24, 38 of the blade mounting members 16, 18 from the lateral slots 17, 19 of the handle assembly 12, the removal force allows the entire removable blade assembly 14 to be removed from the rotary food cutter 10, such as shown in FIG. 2.

Once the removable blade assembly 14 is removed from the handle assembly 12 of the rotary food cutter 10, the removable blade assembly 14 may be disassembled to provide access to the first blade mounting member 16, the second blade mounting member 18, and the blade 20 by applying a separating force that is generally in the opposite direction of the compressive force previously applied. The separating force removes the male interlocking member 32 of the first blade mounting member 16 from the female interlocking member 42 of the second blade mounting member 18. The blade 20 may then be removed from the blade bearing surface 28 of the first blade mounting member 16.

Once the blade 20 is removed from the removable blade assembly 14, the blade 20 may be thoroughly cleaned, as access to at least a majority of the blade 20 surface is possible. Further, the blade 20 may be replaced, such as, for example, with a replacement blade with a different cutting edge, such as a serrated edge, or the replacement blade may be generally identical to the initial blade 20, such as a clean blade, or a new blade if the initial blade 20 is worn or damaged.

To reassemble the removable blade assembly 14, the blade 20 is placed on the blade bearing surface 28 of the first blade mounting member 16. The alignment feature 34 of the first blade mounting member 16 is positioned relative to the alignment feature 44 of the second blade mounting member 18, allowing the male interlocking member 32 of the first blade mounting member 16 to be inserted into the female interlocking member 42 of the second blade mounting member 18. Once the male interlocking member 32 is fully inserted into the female interlocking member 42, the removable blade assembly 14 is fully assembled.

Once the removable blade assembly 14 is assembled, it may be inserted into the handle assembly 12 to form the rotary food cutter assembly 10. To insert the removable blade assembly 14 into the handle assembly 12, compressive forces may once again be applied to the first release surface 26 of the first blade mounting member 16 and the second release surface 40 of the second blade mounting member 18, to deflect the displaceable arms 22, 36 towards the center of the removable blade assembly 14. While the compressive forces are being applied, the removable blade assembly 14 is inserted into the handle assembly 12. The laterally protruding ledge 24 of the first blade mounting member 16 inserts into the first lateral slot 17 of the handle assembly 12 once the compressive force is no longer being applied to the first release surface 26. Similarly, the laterally protruding ledge 38 of the second blade mounting member inserts into the second lateral slot 19 of the handle assembly 12 once the compressive force is no longer being applied to the second release surface 40. The interaction of the laterally protruding ledges 24, 40 of the first and second blade mounting members 16, 18 with the first and second lateral slots 17, 19 of the handle assembly 12 secures the removable blade assembly 14 to the handle assembly 12. The rotary food cutter 10 may then be used with the blade 20 cutting the food product as the user grasps the handle assembly 12.

It is also contemplated that the removable blade assembly 14 may be inserted into the handle assembly without the need to apply compressive forces to the first release surface 26 and the second release surface 40 by having the protruding ledges 24, 40 of displaceable arms 22, 36 contact the handle assembly 12 until the protruding ledges 24, 40 reach the first and second lateral slots 17, 19. Once the lateral protruding ledges 24, 40 reach the lateral slots 17, 19 of the handle assembly 12, the displaceable arms 22, 36 move towards the outside of the rotary cutter 10 as a force is no longer applied to the displaceable arms 22, 36 by the contact between the handle assembly 12 and the protruding ledges 24, 40.

While the specific embodiments have been illustrated and described, numerous modifications come to mind without significantly departing from the spirit of the invention, and the scope of protection is only limited by the scope of the accompanying Claims.

What is claimed is:

1. A rotary food cutting device comprising:
a handle assembly; and
a removable blade assembly comprising a first blade mounting member and a second blade mounting member, the first and second blade mounting members defining a blade locking mechanism provided for removable coupling engagement of the blade assembly with the handle assembly, and a blade coupled to the blade locking mechanism and being positioned between the first blade mounting member and the second blade mounting member.

2. The rotary food cutting device of claim 1, wherein the blade is a pizza cutting blade.

3. The rotary food cutting device of claim 1, wherein the blade has a generally straight edge.

4. The rotary food cutting device of claim 1, wherein the first blade mounting member comprises a first displaceable arm having a generally laterally protruding ledge at a distal end of the arm, a blade bearing surface adapted to support the blade during use of the rotary cutter, and wherein the second blade mounting member comprises a second displaceable arm having a generally laterally protruding ledge at a distal end of the arm.

5. The rotary food cutting device of claim 4, wherein the first displaceable arm connects to a first release surface, the first release surface being configured as a generally concave surface, and wherein the second displaceable arm connects to the a second release surface, the second release surface being configured as a generally concave surface.

6. The rotary food cutting device of claim 1, wherein the handle assembly further comprises a first body member and a second body member, the first body member having a first lateral slot and the second body member having a second lateral slot, the first lateral slot being adapted for receiving the generally laterally protruding ledge of the first blade mounting member to secure the first blade mounting member to the handle assembly, the second lateral being slot adapted for receiving the generally laterally protruding ledge of the second blade mounting member to secure the second blade mounting member to the handle assembly.

7. The rotary food cutting device of claim 1, wherein the handle assembly further comprises a thumb grip, the thumb grip being positioned on a top surface of the handle.

8. A removable blade assembly for a rotary food cutter comprising:
a first blade mounting member having:
a displaceable arm having a ledge at a distal end of the arm;
a rotary cutting blade bearing surface; and
a male interlocking member concentric to the rotary cutting blade bearing surface, the male interlocking member extending in an axial direction beyond the rotary cutting blade bearing surface;
a second blade mounting member having:
a displaceable arm having a ledge at a distal end of the arm; and
a female interlocking member with a recess formed in an axial direction;
wherein the male interlocking member of the first blade mounting member projects into the female interlocking member of the second blade mounting member fixing the positions of the first blade mounting member relative to the second blade mounting member; and
a rotary food cutting blade having an opening formed proximate a central portion of the food cutting blade, the rotary food cutting blade being supported by the rotary cutting blade bearing surface projecting through the opening of the rotary cutting blade.

9. The removable blade assembly of claim 8, wherein the displaceable arm of the first blade mounting member is coupled to a first release surface having a generally concave shape.

10. The removable blade assembly of claim 8, wherein the displaceable arm of the second blade mounting member is coupled to a second release surface having a generally concave shape.

11. The removable blade assembly of claim 8, wherein the male interlocking member has a first alignment feature, and the female interlocking member has a second alignment feature, wherein the first and second alignment features cooperate to limit a number of positions of the first blade mounting member relative to the second blade mounting member.

12. The removable blade assembly of claim 11 wherein the first alignment feature is a generally flat surface and the second alignment feature is a generally flat surface.

13. A method of operating a rotary food cutter comprising:
providing a handle assembly;
providing a removable blade assembly having a blade, a first blade mounting member having a first displaceable arm having a generally laterally protruding ledge at a distal end of the arm, a blade bearing surface adapted to support the blade during use of the rotary cutter, and a second blade mounting member having a second displaceable arm having a generally laterally protruding ledge at a distal end of the arm, the blade being removably secured between the first blade mounting member and the second blade mounting member;
applying a force to the displaceable arms to deflect the displaceable arms and move the laterally protruding ledges of the blade mounting members to a disengaged position;
removing the removable blade assembly from the handle assembly; and
separating the removable blade assembly by pulling the first blade mounting member away from the second blade mounting member.

14. The method of claim 13, wherein the act of applying a force results in deflecting the displaceable arms towards a center of the rotary food cutter.

15. The method of claim 14, wherein the act of deflecting the displaceable arms results in disengagement of the laterally protruding ledges of the blade assembly from laterally slots in the handle assembly.

16. The method of claim 13 wherein the act of separating the removable blade assembly provides access to the blade.

17. The method of claim 18 further comprising:
cleaning the blade; and
reengaging the removable blade assembly by moving the first blade assembly towards the second blade mounting member with the blade between the blade mounting members.

18. The method of claim 15 further comprising:
replacing the blade with a second blade;
forming a modified removable blade assembly by moving the first blade mounting member towards the second blade mounting member; and
mounting the modified removable blade assembly in the handle assembly.
